(19) United States
(12) Patent Application Publication
(10) Pub. No.: US 2013/0168928 A1
(43) Pub. Date: Jul. 4, 2013

(54) SLIDING RING WITH IMPROVED RUN-IN PROPERTIES

(71) Applicants: Andreas Schrüfer, Wolfratshausen (DE); Jörg Thelke, Wolfratshausen (DE); Michael Riedl, Berg/Hohenrain (DE); Lothar Schäfer, Meine (DE); Markus Armgardt, Braunschweig (DE); Markus Höfer, Gardessen (DE)

(72) Inventors: Andreas Schrüfer, Wolfratshausen (DE); Jörg Thelke, Wolfratshausen (DE); Michael Riedl, Berg/Hohenrain (DE); Lothar Schäfer, Meine (DE); Markus Armgardt, Braunschweig (DE); Markus Höfer, Gardessen (DE)

(73) Assignee: EagleBurgmann Germany GmbH & Co. KG, Wolfratshausen (DE)

(21) Appl. No.: 13/814,519

(22) PCT Filed: Mar. 22, 2011
(86) PCT No.: PCT/EP11/01422

§ 371 Date: Mar. 14, 2013

(30) Foreign Application Priority Data
Aug. 9, 2010 (DE) 20 2010 011 173.0

(51) Int. Cl. F16J 15/16

(52) U.S. Cl. CPC F16J 15/162
USPC 277/500; 427/402

(57) ABSTRACT

The present invention refers to a seal ring comprising: a base region (20), a diamond coating (21) applied to the base region (20), and a lubricant coating (22) applied to the diamond coating (21), which adheres to the diamond coating and fills recesses (23) of the diamond coating (21). Furthermore, the present invention refers to a mechanical seal comprising at least one seal ring according to the invention.

The present invention refers to a seal ring and a mechanical seal, respectively, which comprises a diamond coating and has improved run-in properties. Furthermore, the present invention refers to a manufacturing method for a seal ring.

Seal rings and mechanical seals are known from the prior art in various configurations. During operation the seal rings often have to withstand very high loads, particularly high pressure and temperature loads. To this end the prior art (DE 20 2007 016 868 U1) has suggested that a seal ring should be provided with a base body of carbidic material with a sliding surface of diamond material. It has now been found that in mechanical seals with diamond-coated seal rings an increased leakage as compared with mechanical seals without diamond coatings may occur before and during the putting into operation because of the microcrystalline structure of the diamond coating. Hence, due to the potential leakage an undesired increased leakage may occur before the putting into operation and during the run-in period of the mechanical seal until the tips of the diamond coating are ground in after a certain operating time and tightness is guaranteed.

Especially in the case of toxic or other environmentally harmful media, such an initial leakage has however to be avoided.

It is therefore the object of the present invention to provide a diamond-coated seal ring and a mechanical seal with diamonded-coated seal rings which also before and during a run-in phase guarantees a safe and leakage-free sealing.

Furthermore, it is the object of the present invention to indicate a method for producing a diamond-coated seal ring which particularly shows improved run-in properties.

This object is achieved by a seal ring and a mechanical seal comprising the features of claims 1 and 8, respectively. The sub-claims refer to preferred developments of the present invention.

The seal ring according to the invention comprises a base region with a diamond coating applied thereto, and a lubricant coating applied to the diamond coating. The lubricant coating is adhesively bonded to the diamond coating and adheres to the surface of the diamond coating. Particularly the lubricant coating fills recesses in the diamond coating so that the microcrystalline structure of the diamond coating shows a reduced roughness due to the filling lubricant coating. Thus the additional lubricant coating has the function of a run-in layer and provides for a higher tightness of the mechanical seal as compared with diamond-coated seal rings without such a lubricant coating.

Preferably, the lubricant coating is applied to the diamond coating in such a manner that tips of the diamond coating still protrude from the lubricant coating. Hence, the lubricant coating just partially fills the recesses between the diamond tips. This has the advantage that a wear resistance of the sliding surfaces is maintained due to the high hardness of the diamond crystals protruding from the lubricant coating. The tips are here minimally protruding from the lubricant coating. Preferably, the tips protrude in a range of from 0 μm to 8 μm, particularly preferably from 1 μm up to 6 μm.

Alternatively, the lubricant coating is applied to the diamond coating in such a manner that the tips of the diamond coating end with the lubricant coating and form a sliding surface of high flatness.

According to a further alternative configuration of the invention the lubricant coating fully covers the diamond coating. A particularly flat sliding surface can thereby be attained, so that such a mechanical seal is virtually leakage-free after assembly. During operation and after a certain operation period of several hours or days the lubricant coating can be abraded, so that the diamond coating having a lubricant coating still existing in the recesses then shows the desired high resistance to wear.

The lubricant coating preferably comprises a dry lubricant, a binder and optionally volatile components. Graphite may e.g. be used as the dry lubricant. The binder may be an organic or inorganic binder. The lubricant coating is particularly preferably an anti-friction lacquer that can be sprayed on. Alternatively, the lubricant coating may also be applied by dipping or spreading. The lubricant coating is particularly preferably resistant to high temperatures and has an operating temperature range of about −50° C. to +300° C.

According to a further preferred configuration of the present invention a thickness of the lubricant coating is approximately equal to a thickness of the diamond coating. It is thereby ensured that the lubricant coating extends at least up to the tips of the diamond coating, e.g. if the diamond coating should for instance comprise a gap on the base region and said gap is filled by the lubricant coating from the base region up to the tip. If it is to be ensured that tips of the diamond coating are to protrude from the lubricant coating, the thickness of the lubricant coating is preferably not more than half the thickness of the diamond coating.

Further preferably, the lubricant coating annularly covers only a portion of the diamond coating in radial direction. This can guarantee the necessary tightness by the surrounding lubricant coating without the whole diamond coating having to be covered with the lubricant coating. Furthermore, this preferred configuration can achieve a faster running- in of the seal rings.

Furthermore, the present invention refers to a mechanical seal comprising at least one seal ring according to the invention. Particularly preferably, both seal rings are configured as seal rings according to the invention with diamond coating and additionally applied lubricant coating.

Furthermore, the present invention refers to a method for producing a seal ring, comprising the steps of: producing a base region, preferably of silicon carbide or tungsten carbide, applying a diamond coating to a sliding side of the base region, and applying a lubricant coating to the diamond coating, with an adhesive bond being established between the lubricant coating and the diamond coating. The lubricant coating is preferably sprayed on in the form of an anti-friction lacquer or applied by a dipping process or by spreading on the diamond coating. The method according to the invention further preferably comprises a hardening step which lasts for at least 12 hours and is carried out at room temperature. Further preferably, the method according to the invention comprises a subsequent polishing step in which the lubricant coating is removed up to the diamond tips to provide a sliding surface which is as flat as possible and shows low roughness.

Hence, according to the invention the application of the lubricant coating does not improve a friction behavior of the mechanical seal that in the case of diamond-coated seal rings is inherently excellent, but a roughness of the diamond coating of an unused (new) seal ring is reduced so as to reduce or avoid a standstill leakage and a start leakage of new seal rings. Owing to the filling of the recess in the diamond coating, especially leakage routes are closed and leakage is thereby prevented.

The seal ring according to the invention can be used in both liquid-lubricated mechanical seals and in gas-lubricated mechanical seals.

Preferred embodiments of the invention will now be described in detail with reference to the accompanying drawing, in which:

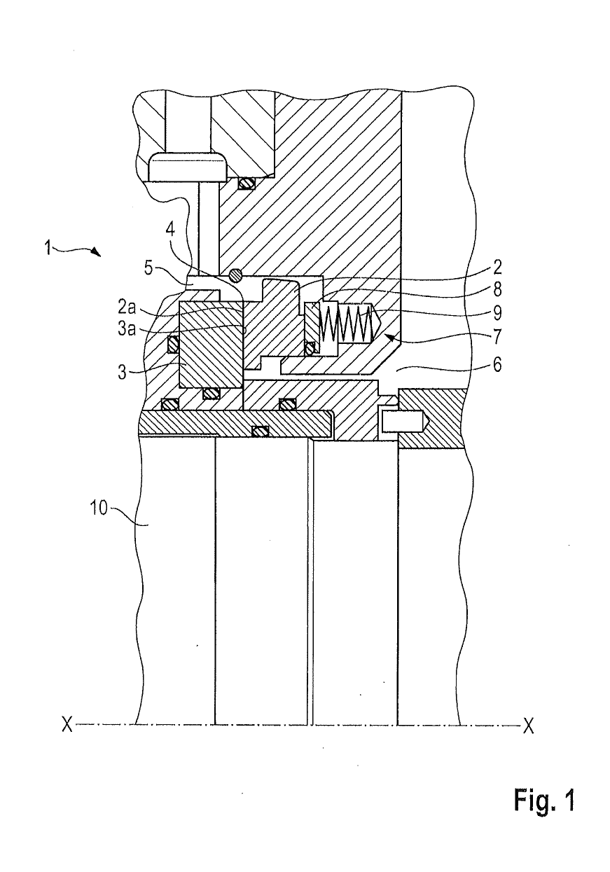

FIG. 1 is a schematic sectional view of a mechanical seal according to a first embodiment of the invention;

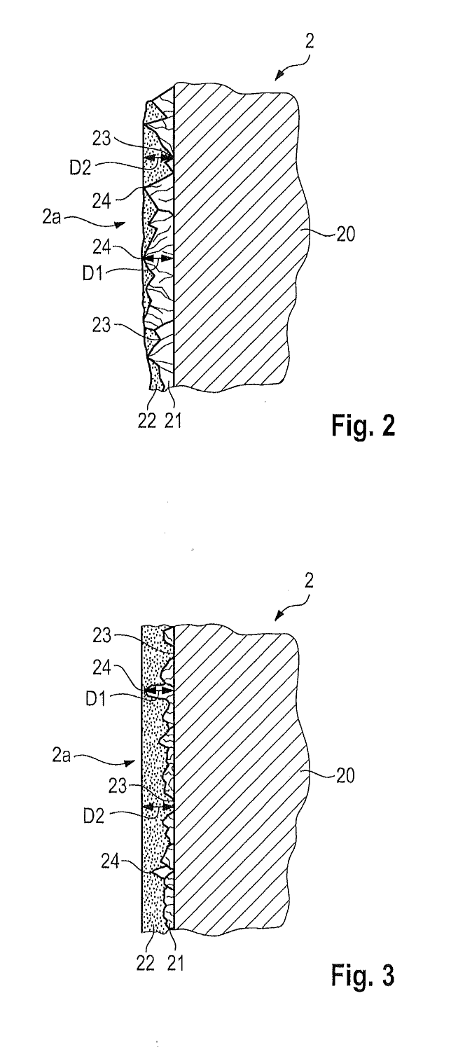

FIG. 2 is a sectional view of the stationary seal ring of FIG. 1; and

FIG. 3 is a sectional view of a seal ring according to a second embodiment of the invention.

A mechanical seal 1 according to a first preferred embodiment of the invention will now be described in detail with reference to FIGS. 1 and 2.

As can be seen in FIG. 1, the mechanical seal 1 comprises a stationary seal ring 2 and a rotating seal ring 3. The rotating seal ring 3 rotates together with a rotating component 10, e.g. a shaft. The seal rings 2, 3 have sliding surfaces 2a and 3a which are opposite to each other and define a seal gap 4 thereinbetween. The mechanical seal 1 seals the area between a first chamber 5 and a second chamber 6 on the rotating shaft 10. Furthermore, the mechanical seal 1 comprises a biasing means 7 with a force transmitting ring 8 and a plurality of biasing springs 9 distributed along the circumference. The biasing means 7 biases the stationary seal ring 2 against the rotating seal ring 3. X-X designates a rotation axis of the rotating component 10.

FIG. 2 is an enlarged sectional view of the stationary seal ring 2. The stationary seal ring 2 comprises a base region 20, a diamond coating 21 applied thereto, as well as a lubricant coating 22 applied to the diamond coating 21. The lubricant coating 22 is adhesively bonded to the diamond coating 21 and comprises a dry lubricant, such as graphite. The lubricant coating 22 fills recesses 23 in the diamond coating 21. Two recesses 23 are plotted in FIG. 2 by way of example. Reference numeral 24 designates two tips of the diamond coating by way of example. FIG. 2 shows a condition of the stationary seal ring 2 that is as good as new, wherein in a first step the diamond coating 21 is applied to the base region 20, the lubricant coating 22 is then applied to the diamond coating 21, and the lubricant coating is subsequently removed up to the highest tips 24 of the diamond coating, resulting in a sliding surface 2a of high flatness in the case of which the recesses 23 of the diamond coating are completely filled with the lubricant coating 22.

Since the recesses 23 in the diamond coating 21 can partly extend up to the base region 20 (illustrated in FIG. 2 by way of example at the upper recess 23), a maximum thickness D1 of the diamond coating is equal to a maximum thickness D2 of the lubricant coating 22 in the area of the greatest recess 23. The maximum thickness D1 of the diamond coating extends here from the base region 20 up to the end of the tip 24, with the tip directly ending on the sliding surface 2a.

In the first embodiment, the two seal rings 2, 3 are of the same structure, so that after the mechanical seal has been assembled the two sliding surfaces 2a, 3a end close to each other, due to the bias of the biasing means 7, so that no leakage occurs. After operation for a few hours or days the tips 24 of the diamond coating 21 are partly smoothed, with the lubricant coating 22 being also slightly removed, whereby the flatness of the sliding surfaces 2a, 3a is further improved.

FIG. 3 shows a seal ring 2 according to a second embodiment of the invention, wherein identical or functionally identical members are designated with the same reference numerals as in the first embodiment. The embodiment shown in FIG. 3 substantially corresponds to the first embodiment, wherein in contrast thereto the tips 24 of the diamond coating 21 do not protrude from the lubricant coating 22 and do not extend up to the sliding surface 2a. A thickness D2 of the lubricant coating 22, which in the area of very deep recesses 23 extends up to the base region 20, is thereby greater than a maximum thickness D1 of the diamond coating 21 in the area of the tips 24. A particularly flat sliding surface of low roughness can thereby be accomplished. After a certain running-in of the mechanical seal the topmost lubricant coating 22 is abraded, so that the tips 24 of the diamond coating 21 also rest on the sliding surface 2a and the wear resistance of the sliding surfaces corresponds to that of exclusively diamond-coated sliding surfaces.

### List of Reference Numerals

1 Mechanical Seal

2 Stationary Seal Ring

3 Rotating Seal Ring

2a, 3a Sliding Surfaces

4 Seal Gap

5 First Chamber

6 Second Chamber

7 Biasing Means

8 Force Transmitting Ring

9 Biasing Springs

10 Rotating Component

20 Base Region

21 Diamond Coating

22 Lubricant Coating

23 Recess

24 Tip of the Diamond Coating

D1 Maximum Thickness of the Diamond Coating

D2 Maximum Thickness of the Lubricant Coating

X-X Rotating Axis of the Rotating Component 10

1. A seal ring comprising:
a base region,
a diamond coating applied to the base region, and a lubricant coating applied to the diamond coating, which adheres to the diamond coating and fills recesses of the diamond coating.

2. The seal ring according to claim 1, wherein the lubricant coating is applied to the diamond coating in such a manner that tips of the diamond coating protrude from the lubricant coating.

3. The seal ring according to claim 1, wherein tips end with the lubricant coating and form a flat sliding surface.

4. The seal ring according to claim 1, wherein the lubricant coating fully covers the diamond coating.

5. The seal ring according to in that claim 1, wherein the lubricant coating comprises a dry lubricant, particularly graphite, and a binder.

6. The seal ring according to claim 1, wherein a thickness (D2) of the lubricant coating is equal to a thickness (D1) of the diamond coating.

7. The seal ring according to claim 1, wherein the lubricant coating annularly covers only a portion of the diamond coating in radial direction.

8. A mechanical seal comprising one or two seal rings, constructed according to claim 1.

9. A method for producing a seal ring, comprising the steps of:
producing a base region, preferably of silicon carbide or tungsten carbide,
applying a diamond coating to a sliding side of the base region, and
applying a lubricant coating to the diamond coating, with an adhesive bond being established between the lubricant coating and the diamond coating.

10. The method according to claim 9, wherein the lubricant coating is sprayed on or applied by a dipping process or by spreading on the diamond coating.

11. The method according to claim 9, wherein the lubricant coating is an anti-friction lacquer.

12. The method according to claims 9, wherein a subsequent polishing step in which lubricant coating is removed up to the diamond tips to provide a flat sliding surface.
